(19) United States
(12) Patent Application Publication
(10) Pub. No.: US 2025/0382481 A1
(43) Pub. Date: Dec. 18, 2025

(54) AQUEOUS OFFSET INK AND PREPARATION METHOD THEREFOR

(71) Applicant: Byoung Chan LEE, Yongin-si, Gyeonggi-do (KR)

(72) Inventor: Kwang Mo LEE, Yongin-si, Gyeonggi-do (KR)

(73) Assignee: Byoung Chan LEE, Yongin-si, Gyeonggi-do (KR)

(21) Appl. No.: 18/877,275

(22) PCT Filed: Jun. 21, 2023
(86) PCT No.: PCT/KR2023/008636

§ 371 Date: Dec. 20, 2024

(30) Foreign Application Priority Data
Jun. 21, 2022 (KR) 10-2022-0075354

(51) Int. Cl. C09D 11/102; C09D 7/80; C09D 11/107

(52) U.S. Cl. CPC C09D 11/102; C09D 7/80; C09D 11/107

(57) ABSTRACT

The present invention relates to an aqueous offset ink and a preparation method therefor, the ink using an aqueous acrylic, an aqueous urethane and a polyester so as to improve the atmospheric environment, provide an eco-friendly printing environment, make nontoxic prints, and maintain adhesive strength, water resistance and abrasion resistance, which are the advantages of a synthetic resin.

### TECHNICAL FIELD

The present invention relates to an aqueous offset ink and a preparation method therefor, specifically to an aqueous offset ink including an aqueous acryl, aqueous urethane, and polyester so as to improve the atmospheric environment, provide an eco-friendly printing environment, make nontoxic prints, and maintain the advantages of synthetic resins, such as adhesive strength, water resistance and abrasion resistance, and a method of preparing the same.

### BACKGROUND ART

General paper printing uses an offset method in which ink is transferred to a flat surface to print. Offset printing is used across industries for printed materials and product packaging, and the amount of offset printing ink used in offset printing is large.

Generally, the composition of offset printing ink is made up of oil-based materials such as pigments, resins, vegetable oils, petroleum-based organic solvents, and additives.

Petroleum-based organic solvents used in offset printing are known to cause various environmental problems, especially as volatile organic compound (VOC)-generating substances, and have harmful effects on the workers in the printing industry and those exposed to them.

Recently, efforts have been made to apply related technologies and inks to replace oil-based inks due to these environmental and health issues. However, technology that satisfies not only the eco-friendliness of printing ink but also the printing quality and printing process efficiency is still underdeveloped, especially in aqueous printing, due to the offset printing method that utilizes the chemical properties of oil and water repelling each other.

When ink does not contain petroleum-based organic solvents, since this is contrary to the hydrophobic nature of offset printing, that is, the property of repelling water and not mixing with water, it is necessary to develop a technology that maintains printing quality without containing organic solvents of oil-based ink.

There is a need to develop commercially viable aqueous offset printing inks that are environmentally friendly and efficient in the printing process, and offer good printing quality.

Meanwhile, registered Patent No. 10-1927730 discloses an eco-friendly offset ink for printing, which does not contain hydroquinone and a petroleum-based organic solvent, and has a composition including 20 to 40 wt % of a first rosin-modified phenol resin vehicle, 10 to 30 wt % of a second rosin-modified phenol resin vehicle, 10 to 30 wt % of a third rosin-modified phenol resin vehicle; 5 to 25 wt % of pigment, 1 to 3 wt % of a cyclodextrin-metal desiccant, and an extra fatty acid methyl ester as a solvent, and a method of preparing the same.

### DISCLOSURE

### Technical Problem

An embodiment of the present invention is directed to providing a commercially viable aqueous ink for offset printing, which is environmentally friendly and free of toxins and odor, improves the working environment of workers, and exhibits efficiency in a printing process and good printing quality, and a method of preparing the same.

### Technical Solution

An aqueous offset ink of the present invention is composed of 10 to 20 wt % of an aqueous acryl, 20 to 30 wt % of aqueous urethane, 10 to 15 wt % of polyester, 20 to 40 wt % of water, 5 to 10 wt % of ethanol, 10 to 20 wt % of a pigment, and 0.5 to 5 wt % of an additive.

### Advantageous Effects

According to the present invention, an aqueous offset ink including an aqueous acryl and aqueous urethane, which are aqueous materials that deviate from the composition of existing oil-based offset inks, and a polyester can improve the atmospheric environment, provide an eco-friendly printing environment, and make nontoxic prints. In addition, the aqueous offset ink of the present invention maintains the advantages of synthetic resins, such as adhesive strength, water resistance and abrasion resistance.

The aqueous offset ink of the present invention can have excellent adhesion to various substrates, allow appropriate drying speed control, does not generate VOCs unlike conventional oil-based offset inks, and can be used as a replacement in a printing device for oil-based offset ink.

Meanwhile, the present invention has the advantage of easy procurement of raw materials by using types of resin such as an aqueous acryl, aqueous urethane, and polyester in the composition.

The effects of the present invention are not limited to the effects mentioned above, and other effects not mentioned will be clearly understood by those skilled in the art from the description below.

### BRIEF DESCRIPTION OF DRAWINGS

FIG. 1 is a flowchart showing a method of preparing an aqueous offset ink according to an embodiment of the present invention.

FIG. 2 is a view illustrating a bleeding experiment of an aqueous offset ink according to the embodiment of the present invention.

FIG. 3 is a view illustrating a bleeding experiment of an aqueous offset ink according to the embodiment of the present invention.

### MODES OF THE INVENTION

Hereinafter, preferred embodiments of the present invention will be described in detail with reference to the accompanying drawings. However, the embodiments of the present invention may be modified into various other forms, and the scope of the present invention is not limited to the embodiments described below. In addition, the embodiments of the present invention are provided to more completely explain the present invention to those with average knowledge in the relevant technical field. Accordingly, the shape and size of elements in the drawings may be exaggerated for clearer explanation, and elements indicated by the same symbol in the drawings are the same elements.

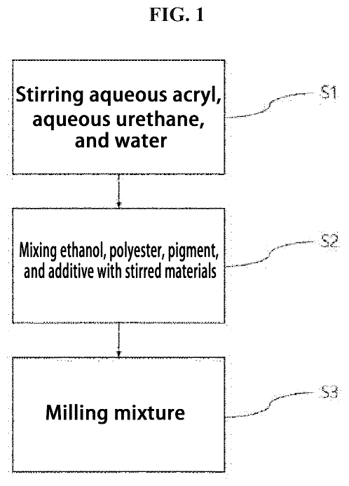

FIG. 1 is a flowchart showing a method of preparing an aqueous offset ink according to an embodiment of the present invention, and FIG. 2 is a view illustrating a bleeding experiment of an aqueous offset ink according to an embodiment of the present invention.

The present invention relates to an aqueous offset ink and a method of preparing the same, wherein components of the ink composition are an aqueous acryl, aqueous urethane, polyester, water, ethanol, a pigment, and an additive.

The aqueous acrylic resin is an acrylic resin that uses water as a solvent, and may include acrylic monomers such as acrylic acid and metamethacrylate. The aqueous acrylic resin improves the weather resistance of ink, preventing it from deteriorating in various climates, and helps to provide gloss. In addition, the aqueous acrylic resin adds to the abrasion resistance of the ink and helps maintain adhesive strength. In a preferred embodiment of the present invention, the aqueous acrylic resin is included in a composition ratio of 10 to 30 wt %.

The aqueous urethane resin is a urethane resin that uses water as a solvent and is a component that maintains adhesiveness, and in a preferred embodiment of the present invention, it is included in a composition ratio of 20 to 30 wt %.

Water (H₂O) acts as a solvent for the resin and serves to maintain the stability of the ink. In a preferred embodiment of the present invention, water is included in a composition ratio of 20 to 40 wt %.

Polyester provides flexibility to synthetic resin and makes it stick to the fabric, and in a preferred embodiment of the present invention, it is included in a composition ratio of 10 to 15 wt %.

Ethanol is a medium in which resin and water both dissolve, and helps the ink mix well. In a preferred embodiment of the present invention, ethanol is included in a composition ratio of 5 to 10 wt %.

The pigment determines the color of the ink. Pigments of various colors can be used, and the intensity of the ink color may be adjusted depending on the amount of pigment included. In a preferred embodiment of the present invention, the pigment is included in a composition ratio of 10 to 20 wt %, and since the color of the ink is determined according to the weight ratio of the pigment, the pigment weight ratio is determined according to the required color of ink, and the weight ratio of the remaining components is adjusted accordingly to determine the overall composition ratio.

In addition, the aqueous ink used in the present invention additionally includes an additive. The additive may be added in a small amount to enable the aqueous ink to have excellent printing characteristics. Specifically, a dispersant for providing dispersing and surface activity effects to a colorant, an antifoaming agent for preventing bubbles generated during the ink preparation process, a wax for preventing ink from smudging and improving the gloss of the ink, and a leveling agent for controlling the surface tension of the ink surface to improve leveling properties and also for the purpose of improving storage stability and quality may be included and used as additives.

The core of the embodiment of the present invention is the composition ratio of the constituent substances. Since the offset ink utilizes the property that water and ink do not mix but rather repel each other, it can be used as is in commonly used offset printing machines while maintaining the same quality as conventional oil-based ink. In the offset printing process, when the repulsive force is insufficient or the transfer force to the printing plate and rubber roller is low, printing quality deteriorates. However, even though it is an aqueous ink, the printing quality is maintained in the composition ratio of the embodiment of the present invention.

The method of preparing an aqueous offset ink having the above composition ratio includes stirring 10 to 30 wt % of an aqueous acryl, 20 to 30 wt % of aqueous urethane, and 20 to 40 wt % of water; mixing 5 to 10 wt % of ethanol, 10 to 15 wt % of polyester, 10 to 20 wt % of a pigment, and 0.5 to 5 wt % of an additive with the stirred materials; and milling the mixture.

At this time, milling refers to uniformly mixing and grinding compositions through heat and mechanical action.

Meanwhile, the preparation method of the present invention can be performed under heating or pressure, and it is necessary to maintain a temperature between room temperature and 200° C. from the initial stirring step to the milling step.

Hereinafter, the present invention will be described in detail by way of examples. However, these examples are for illustrative purposes only, and the scope of the present invention is not limited to these examples.

### EXAMPLE 1

An aqueous acryl, aqueous urethane, and water were first stirred, ethanol, polyester, pigment, and additives were input therein and mixed, and then the mixture was milled to prepare an aqueous offset ink. The composition ratio of each component is as shown in the table below.

TABLE 1

| Components | wt % |
|---|---|
| Aqueous acryl | 13 |
| Aqueous urethane | 20 |
| Polyester | 11 |
| Water | 40 |
| Ethanol | 5 |
| Pigment | 10 |
| Additive | 1 |

### EXAMPLE 2

An aqueous offset ink was prepared in the same manner as in Example 1. The composition ratio of each component is as shown in the table below.

TABLE 2

| Components | wt % |
|---|---|
| Aqueous acryl | 24 |
| Aqueous urethane | 20 |
| Polyester | 15 |
| Water | 20 |
| Ethanol | 10 |
| Pigment | 10 |
| Additive | 1 |

### EXAMPLE 3

An aqueous offset ink was prepared in the same manner as in Example 1. The composition ratio of each component is as shown in the table below.

TABLE 3

| Components | wt % |
|---|---|
| Aqueous acryl | 29 |
| Aqueous urethane | 20 |
| Polyester | 10 |
| Water | 20 |
| Ethanol | 10 |
| Pigment | 10 |
| Additive | 1 |

### EXAMPLE 4

An aqueous offset ink was prepared in the same manner as in Example 1. The composition ratio of each component is as shown in the table below.

TABLE 4

| Components | wt % |
|---|---|
| Aqueous acryl | 14 |
| Aqueous urethane | 20 |
| Polyester | 10 |
| Water | 40 |
| Ethanol | 5 |
| Pigment | 10 |
| Additive | 1 |

### EXAMPLE 5

An aqueous offset ink was prepared in the same manner as in Example 1. The composition ratio of each component is as shown in the table below.

TABLE 5

| Components | wt % |
|---|---|
| Aqueous acryl | 10 |
| Aqueous urethane | 22 |
| Polyester | 12 |
| Water | 40 |
| Ethanol | 5 |
| Pigment | 10 |
| Additive | 1 |

### EXAMPLE 6

An aqueous offset ink was prepared in the same manner as in Example 1. The composition ratio of each component is as shown in the table below.

TABLE 6

| Components | wt % |
|---|---|
| Aqueous acryl | 10 |
| Aqueous urethane | 24 |
| Polyester | 10 |
| Water | 40 |
| Ethanol | 5 |
| Pigment | 10 |
| Additive | 1 |

### EXAMPLE 7

An aqueous offset ink was prepared in the same manner as in Example 1. The composition ratio of each component is as shown in the table below.

TABLE 7

| Components | wt % |
|---|---|
| Aqueous acryl | 14 |
| Aqueous urethane | 30 |
| Polyester | 15 |
| Water | 20 |
| Ethanol | 10 |
| Pigment | 10 |
| Additive | 1 |

### EXAMPLE 8

An aqueous offset ink was prepared in the same manner as in Example 1. The composition ratio of each component is as shown in the table below.

TABLE 8

| Components | wt % |
|---|---|
| Aqueous acryl | 15 |
| Aqueous urethane | 30 |
| Polyester | 14 |
| Water | 20 |
| Ethanol | 10 |
| Pigment | 10 |
| Additive | 1 |

### COMPARATIVE EXAMPLE 1

An aqueous offset ink was prepared in the same manner as in Example 1. The composition ratio of each component is as shown in the table below.

TABLE 9

| Components | wt % |
|---|---|
| Aqueous acryl | 21 |
| Aqueous urethane | 11 |
| Polyester | 11 |
| Water | 45 |
| Ethanol | 1 |
| Pigment | 10 |
| Additive | 1 |

### EXPERIMENTAL EXAMPLE 1: BLEEDING EXPERIMENT

The aqueous offset inks of Examples 1 to 8 and Comparative Example I were printed on paper and the presence or absence of bleeding was confirmed.

TABLE 10

| | | | | | | | | | Comparative |
|---|---|---|---|---|---|---|---|---|---|
| | Example 1 | Example 2 | Example 3 | Example 4 | Example 5 | Example 6 | Example 7 | Example 8 | Example 1 |
| Bleeding | None | None | None | None | None | None | None | None | Presence |

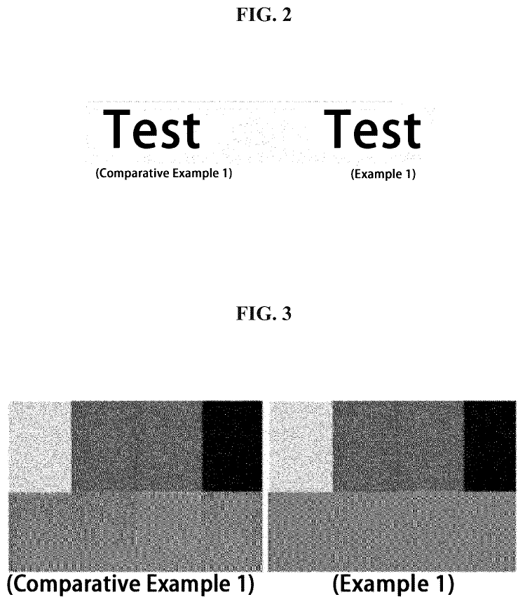

As a result of the experiment, it was found that when printing was done with the aqueous offset inks of Examples 1 to 8, the printing did not bleed, indicating excellent bleeding characteristics. The aqueous offset ink of Comparative Example 1 exhibited bleeding, indicating inferior bleeding characteristics compared to the Examples. FIGS. 2 and 3 are photographs evaluating the bleeding characteristics according to the ethanol content according to Experimental Example 1. Example 1 with an ethanol content of 5 wt % and Comparative Example 1 with an ethanol content of 1 wt %, which had the same content of the components except for ethanol and water, were printed on paper and then the presence or absence of bleeding was confirmed. As shown, it can be seen that the bleeding quality decreases depending on the ethanol content. Therefore, it is advisable to keep the ethanol content at 5 wt % or more as it may adversely affect printing quality in printing using the aqueous offset ink. FIG. 2 illustrates the importance of the composition ratio of examples of the present invention, showing that examples of the present invention can be applied to an offset printing device like a conventional oil-based ink.

In this way, the aqueous offset ink of the present invention can solve environmental and safety problems caused by an oil-based offset ink while exhibiting excellent properties such as printability and bleeding characteristics that are not inferior to those of the oil-based offset ink, and is therefore a useful ink that can replace the oil-based offset ink.

Meanwhile, the embodiments of the present invention disclosed in the present specification and drawings are only specific embodiments presented to easily explain the technical content of the present invention and help in understanding the present invention, and are not intended to limit the scope of the present invention. It will be apparent to those skilled in the art that other modifications based on the technical concept of the present invention can be implemented in addition to the embodiments disclosed herein.

### Industrial Applicability

According to the present invention, an aqueous offset ink using an aqueous acryl and aqueous urethane, which are aqueous materials that deviate from the composition of existing oil-based offset inks, and polyester can improve the atmospheric environment, provide an eco-friendly printing environment, make nontoxic prints, and maintain the advantages of synthetic resins, such as adhesive strength, water resistance and abrasion resistance.

1. An aqueous offset ink that does not contain a petroleum-based organic solvent, the aqueous offset ink comprising:
10 to 30 wt % of an aqueous acryl, 20 to 30 wt % of aqueous urethane, 10 to 15 wt % of polyester, 20 to 40 wt % of water, 5 to 10 wt % of ethanol, 10 to 20 wt % of a pigment, and 0.5 to 5 wt % of an additive.

2. The aqueous offset ink of claim 1, wherein the additive includes a dispersant.

3. The aqueous offset ink of claim 1, wherein the additive includes an antifoaming agent.

4. The aqueous offset ink of claim 1, wherein the additive includes wax.

5. The aqueous offset ink of claim 1, wherein the additive includes a leveling agent.

6. A method of preparing an aqueous offset ink that does not contain a petroleum-based organic solvent, the method comprising:
stirring 10 to 30 wt % of an aqueous acryl, 20 to 30 wt % of aqueous urethane, and 20 to 40 wt % of water;
mixing 5 to 10 wt % of ethanol, 10 to 15 wt % of polyester, 10 to 20 wt % of a pigment, and 0.5 to 5 wt % of an additive with the stirred materials; and
milling the mixture.
